(19) United States
(12) Patent Application Publication
(10) Pub. No.: US 2026/0370568 A1
(43) Pub. Date: Nov. 19, 2026

(54) METHOD AND DEVICE FOR HANDLING INFORMATION FOR AI/ML APPLICATION IN WIRELESS COMMUNICATION SYSTEM

(71) Applicant: SAMSUNG ELECTRONICS CO., LTD., Suwon-si, Gyeonggi-do (KR)

(72) Inventors: Jungshin PARK, Suwon-si (KR); Dongyeon KIM, Suwon-si (KR); Eric YIP, Suwon-si (KR)

(21) Appl. No.: 19/146,881

(22) PCT Filed: Jan. 10, 2024
(86) PCT No.: PCT/KR2024/000459

§ 371 Date: Jul. 9, 2025

(30) Foreign Application Priority Data
Jan. 11, 2023 (KR) 10-2023-0003977

(51) Int. Cl. H04L 41/16; H04L 41/14

(52) U.S. Cl. CPC H04L 41/16; H04L 41/145

(57) ABSTRACT

The present disclosure relates to a 5G or 6G communication system for supporting a higher data transmission rate. According to an embodiment of the present disclosure, a method for handling information related to an AI/ML service by an AMF in a wireless communication system is provided. The method comprises the steps of: receiving a registration request message including a list of AI/ML operation types requested from a UE; identifying a list of AI/ML operation types allowed for the UE and at least one operation condition for each AI/ML operation type included in the list of AI/ML operation types allowed for the UE; on the basis of the list of requested AI/ML operation types, the list of AI/ML operation types allowed for the UE, and the at least one operation condition, determining whether the UE is allowed to use at least one AI/ML operation type included in the list of requested AI/ML operation types; and upon determination that the UE is not allowed to use the at least one AI/ML operation type included in the list of requested AI/ML operation types, transmitting a registration reject message to the UE.

### TECHNICAL FIELD

The disclosure relates to a method and device for handling information for an artificial intelligence/machine learning (AI/ML) application in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DETAILED DESCRIPTION OF THE INVENTION

### Technical Problem

The 5G system (5GS) recently being commercialized, and long-term evolution (LTE) and LTE-advanced (LTE-A) systems which are currently providing a mobile communication service, all, are mobile communication systems that provide packet-based services. The 5GS is being developed to support interworking with LTE and LTE-A-based evolved packet system (EPS). In the disclosure, the 5GS may be referred to as a 5G system. In the 5G system, a 5G core (5GC) network may provide a UE policy to the UE.

In the 5G system, a connection between a server and a UE for AI/ML services may be supported, and the core network may provide assistance information necessary for AI/ML application operation to each of the UE and the server. The AI/ML service may have different network QoS and operation conditions according to the AI/ML model transfer method and data transmission method, and accordingly, the assistance information required for AI/ML application operation for the UE and the server may also vary. Therefore, the 5G core network may need a method to determine the operation type of the AI/ML application executed by the user and the type of information that the UE user and the server operator may receive from the 5G core network.

Therefore, the disclosure provides a method and device related to providing network information for AI/ML applications to a UE and a server in a 5G system.

### Technical Solution

According to an embodiment of the disclosure, there is provided a method for handling information related to an artificial intelligence/machine learning (AI/ML) service by an access and mobility management function (AMF) in a wireless communication system. The method comprises receiving a registration request message including a list of requested AI/ML operation types from a user equipment UE, identifying a list of AI/ML operation types allowed for the UE and at least one operation condition for each AI/ML operation type included in the list of AI/ML operation types allowed for the UE, determining whether the UE is allowed to use at least one AI/ML operation type included in the list of requested AI/ML operation types, based on the list of requested AI/ML operation types, the list of AI/ML operation types allowed for the UE, and the at least one operation condition, and transmitting a registration reject message to the UE in case of determining that the UE is not allowed to use the at least one AI/ML operation type included in the list of requested AI/ML operation types.

According to an embodiment of the disclosure, there is provided a method for handling information related to an artificial intelligence/machine learning (AI/ML) service by a session management function (SMF) in a wireless communication system. The method comprises receiving, from an access and mobility management function AMF, a protocol data unit PDU session generation request message including at least one of an AI/ML operation type of an AI/ML application installed on a user equipment UE, at least one operation condition related to at least one AI/ML operation type, and information indicating that the UE is located in an AI/ML service area related to the AI/ML operation type of the AI/ML application, identifying subscriber information required for session management related to the UE, the subscriber information required for the session management related to the UE including at least one of a list of AI/ML operation types allowed for the UE and at least one operation condition for each AI/ML operation type included in the list of the AI/ML operation types allowed for the UE, determining whether the AI/ML application is operable in a requested PDU session, based on at least one of the AI/ML operation type of the AI/ML application, the at least one operation condition related to the at least one AI/ML operation type, the information indicating that the UE is located in the AI/ML service area related to the AI/ML operation type of the AI/ML application, and the subscriber information required for the session management related to the UE, and transmitting a PDU session establishment reject message to the AMF in case of determining that the AI/ML application is not operable in the requested PDU session.

According to an embodiment of the disclosure, there is provided a method for handling information related to an artificial intelligence/machine learning (AI/ML) service by a network exposure function (NEF) in a wireless communication system. The method comprises receiving a message for requesting authentication of a type of AI/ML assistance information for a service of an AI/ML application executed on a UE from an application function (AF), identifying subscriber information related to the AI/ML assistance information, identifying allowed AI/ML assistance information based on the identified subscriber information, and transmitting, to the AF, a message including a list the identified allowed AI/ML assistance information.

According to an embodiment of the disclosure, there is provided a device for an access and mobility management function AMF in a wireless communication network. The device comprises a transceiver and at least one processor connected to the transceiver. The at least one processor is configured to receive a registration request message including a list of requested AI/ML operation types from a user equipment UE, identify a list of AI/ML operation types allowed for the UE and at least one operation condition for each AI/ML operation type included in the list of AI/ML operation types allowed for the UE, determine whether the UE is allowed to use at least one AI/ML operation type included in the requested list of AI/ML operation types, based on the list of requested AI/ML operation types, the list of AI/ML operation types allowed for the UE, and the at least one operation condition, and transmit a registration reject message to the UE in case of determining that the UE is not allowed to use the at least one AI/ML operation type included in the list of requested AI/ML operation types.

According to an embodiment of the disclosure, there is provided a device for a session management function (SMF) in a wireless communication network. The device comprises a transceiver and at least one processor connected to the transceiver. The at least one processor is configured to receive, from an access and mobility management function AMF, a protocol data unit PDU session generation request message including at least one of an AI/ML operation type of an AI/ML application installed on a user equipment UE, at least one operation condition related to at least one AI/ML operation type, and information indicating that the UE is located in an AI/ML service area related to the AI/ML operation type of the AI/ML application, identify subscriber information required for session management related to the UE, the subscriber information required for the session management related to the UE including at least one of a list of AI/ML operation types allowed for the UE and at least one operation condition for each AI/ML operation type included in the list of the AI/ML operation types allowed for the UE, determine whether the AI/ML application is operable in a requested PDU session, based on at least one of the AI/ML operation type of the AI/ML application, the at least one operation condition related to the at least one AI/ML operation type, the information indicating that the UE is located in the AI/ML service area related to the AI/ML operation type of the AI/ML application, and the subscriber information required for the session management related to the UE, and transmit a PDU session establishment reject message to the AMF in case of determining that the AI/ML application is not operable in the requested PDU session.

According to an embodiment of the disclosure, there is provided a device for a network exposure function (NEF) in a wireless communication network. The device comprises a transceiver and at least one processor connected to the transceiver. The at least one processor is configured to receive a message for requesting authentication of a type of AI/ML assistance information for a service of an AI/ML application executed on a UE from an application function (AF), identify subscriber information related to the AI/ML assistance information, identify allowed AI/ML assistance information based on the identified subscriber information, and transmit, to the AF, a message including a list the identified allowed AI/ML assistance information.

### BRIEF DESCRIPTION OF DRAWINGS

FIG. 1 illustrates a network structure and interface of a 5G system according to an embodiment of the disclosure;

FIG. 2 illustrates a network architecture and interface of a 5G system according to an embodiment of the disclosure;

FIG. 3 illustrates a network structure and interface of a 5G system according to an embodiment of the disclosure;

FIGS. 4A and 4B illustrate a network structure and interface of a 5G system according to an embodiment of the disclosure;

FIGS. 5A, 5B, and 5C are flowcharts illustrating a procedure related to providing network information for an AI/ML application in a 5G system according to an embodiment of the disclosure;

FIGS. 6A, 6B, and 6C are flowcharts illustrating a procedure related to providing network information for an AI/ML application in a 5G system according to an embodiment of the disclosure;

FIGS. 7A, 7B, and 7C are flowcharts illustrating a procedure related to providing network information for an AI/ML application in a 5G system according to an embodiment of the disclosure;

FIGS. 8A and 8B are flowcharts illustrating a procedure related to providing network information for an AI/ML application in a 5G system according to an embodiment of the disclosure; and

FIG. 9 is a block diagram illustrating a device according to an embodiment of the disclosure.

### MODE FOR CARRYING OUT THE INVENTION

In describing the embodiments, the description of technologies that are known in the art and are not directly related to the present invention is omitted. This is for further clarifying the gist of the present disclosure without making it unclear.

For the same reasons, some elements may be exaggerated or schematically shown. The size of each element does not necessarily reflects the real size of the element. The same reference numeral is used to refer to the same element throughout the drawings.

Advantages and features of the disclosure, and methods for achieving the same may be understood through the embodiments to be described below taken in conjunction with the accompanying drawings. However, the present disclosure is not limited to the embodiments disclosed herein, and various changes may be made thereto. The embodiments disclosed herein are provided only to inform one of ordinary skilled in the art of the category of the present disclosure. The present disclosure is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, the term “unit” is not limited as meaning a software or hardware element. A ‘unit’ may be configured in a storage medium that may be addressed or may be configured to reproduce one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card.

Hereinafter, various embodiments of the disclosure are described in detail with reference to the accompanying drawings. In this case, it should be noted that the same components in the accompanying drawings are indicated by the same reference numerals as much as possible. Further, it should be noted that the accompanying drawings of the disclosure are provided to aid understanding of the present invention, and the present invention is not limited to the form or arrangement illustrated in the drawings of the disclosure. When making the gist of the present invention, the detailed description of known functions or configurations is skipped. It should be noted that in the following description, only parts necessary for understanding the operation according to various embodiments of the present invention are described, and descriptions of other parts will be omitted not to make the gist of the present invention unclear. Further, although the disclosure describes various embodiments using terms used in some communication standards (e.g., 3rd generation partnership project (3GPP)), this is merely an example for description. Various embodiments of the disclosure may be easily modified and applied in other communication systems.

As used herein, each of such phrases as “A/B,” “A or B,” “A and/or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

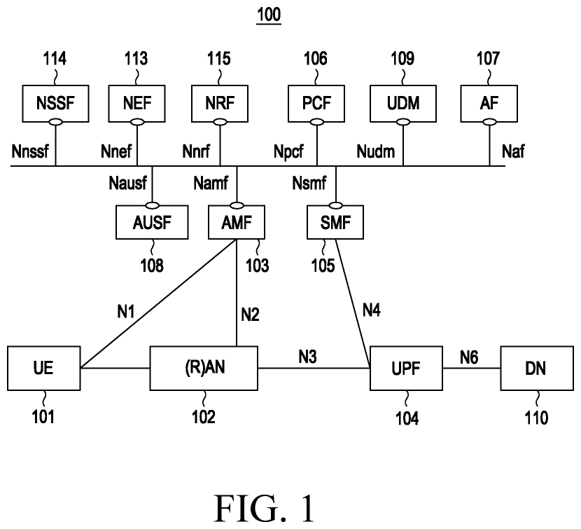

In the disclosure, the network technology may refer to the standards (e.g., TS 23.501, TS 23.502, TS 23.503, etc.) defined by the international telecommunication union (ITU) or 3GPP, and each of the components included in the network architecture of FIG. 1 may mean a physical entity or may mean software that performs an individual function or hardware combined with software. In the drawings, reference numerals shown as Nx, such as N1, N2, N3, . . . , indicate known interfaces between the NFs in the 5G core network (CN).

FIG. 1 is a view illustrating a network structure and interface of a 5G system according to an embodiment of the disclosure.

The network entity included in the network architecture of the 5G system of FIG. 1 may include a network function (NF) according to system implementation.

Referring to FIG. 1, the network structure of the 5G system may include various network entities. As an example, the 5G system may include an authentication server function (AUSF) 108, an (core) access and mobility management function (AMF) 103, a session management function (SMF) 105, a policy control function (PCF) 106, an application function (AF) 107, a unified data management (UDM) 109, a data network (DN) 110, a network exposure function (NEF) 113, a network slicing selection function (NSSF) 114, an edge application service domain repository (EDR) 113, an edge application server (EAS) (not shown), an EAS discovery function (EASDF) (not shown), a user plane function (UPF) 104, a (radio) access network ((R)AN) 102, and a user equipment (UE) (or terminal) 101.

Each NF of the 5G system may support the following functions.

The AUSF 108 may process and store data for authenticating the UE 101.

The AMF 103 provides functions for per-UE access and mobility management and may connect basically to one AMF per UE. Specifically, the AMF 103 may support such functions as inter-CN node signaling for mobility between 3GPP access networks, radio access network (RAN) CP interface (i.e., N2 interface) termination, NAS signaling termination (N1), NAS signaling security (NAS ciphering) and integrity protection, AS security control, registration management (registration area management), connectivity management, idle mode UE reachability (including controlling and performing paging retransmission), mobility management control (subscription and policy), intra-system mobility and inter-system mobility support, support of network slicing, SMF selection, lawful intercept (LI) (for interface to AMF event and LI system), transfer of session management (SM) messages between UE and SMF, transparent proxy for session management (SM) message routing, access authentication, access authorization including a roaming authority check, transfer of SMS messages between UE and short message service function (SMSF), security anchor function (SEA), and security context management (SCM). All or some of the functions of the AMF 103 may be supported in a single instance of one AMF.

The DN 110 may mean, e.g., an operator service, Internet access, or a third party service. The DN 110 may transmit a downlink protocol data unit (PDU) to the UPF 104 or receive a PDU transmitted from UE 101 from the UPF 104.

The PCF 106 may receive information about packet flow from application server and provide the function of determining the policy such as mobility management or session management. Specifically, the PCF 106 may support functions such as support of a signalized policy framework for controlling network operations, providing a policy rule to allow CP function(s) (e.g., AMF or SMF) to execute a policy rule, and implementation of a front end for accessing subscription information related to policy decision in the user data repository (UDR).

The SMF 105 may provide session management function and, if the UE 101 has multiple sessions, this may be managed per session by a different SMF. Specifically, the SMF 105 may support such functions as session management (e.g., session establishment, modification, and release including maintaining tunnel between the UPF 104 and the (R)AN 102 node), UE IP address allocation and management (optionally including authentication), selection and control of a user plane (UP) function, traffic steering settings for routing traffic to a proper destination in UPF 104, interface termination towards policy control functions, execution of control part of policy and QoS, lawful intercept (LI) (for interface to SM event and LI system), termination of SM part of NAS message, downlink data notification, access network (AN)-specific SM information publisher (transferred via the AMF 103 and N2 to the (R)AN 102), session and service continuity (SSC) mode decision of session, and roaming function. All or some of the functions of the SMF 105 may be supported in a single instance of one SMF.

The UDM 109 may store, e.g., user's subscription data, policy data. The UDM 109 may include two parts, i.e., application front end (FE) (not shown) and user data repository (UDR) (not shown).

The front end (FE) (not illustrated) may include a UDM FE in charge of location management, subscription management, and credential processing and a PCF in charge of policy control. The UDR may store data required for the functions provided by UDM-FE and the policy profile required by PCF. The data stored in the UDR may include policy data and user subscription data including a subscription identifier, security credential, access and mobility-related subscription data, and session-related subscription data. The UDM-FE may access the subscription information stored in UDR and support such functions as authentication credential processing, user identification handling, access authentication, registration/mobility management, subscription management, and SMS management.

The UPF 104 may transfer the downlink PDU, received from the DN 110, to the UE 101 via the (R)AN 102 and transfer the PDU, received from the UE 101 via the (R)AN 102, to the DN 110. Specifically, the UPF 104 may support such functions as anchor point for intra/inter RAT mobility, external PDU session point of interconnection to data network, packet routing and forwarding, packet inspection and user plane part of policy rule, lawful intercept, traffic usage reporting, uplink classifier for supporting routing of traffic flow to data network, branching point for supporting multi-home PDU session, QoS handling (e.g., packet filtering, gating, uplink/downlink rate execution) for user plane, uplink traffic verification (SDF mapping between service data flow (SDF) and QoS flow), transport level packet marking in uplink and downlink, downlink packet buffering, and downlink data notification triggering. All or some of the functions of the UPF 104 may be supported in a single instance of one UPF.

The AF 107 may interact with 3GPP core network for providing services (e.g., supporting such functions as application influence on traffic routing, network capability exposure access, and interactions with policy framework for policy control).

The (R)AN 102 collectively refers to new radio access technologies that support both E-UTRA (evolved E-UTRA) which is an evolution from 4G radio access technology and new radio access technology (NR: New Radio) (e.g., gNB).

gNB may support such functions as functions for radio resource management (i.e., radio bearer control, radio admission control, connection mobility control, dynamic allocation of resources (i.e., scheduling) to UE on uplink/downlink), internet protocol (IP) header compression, encryption and integrity protection of user data stream, where routing to AMF is not determined from information provided to UE, selection of an AMF when UE attaches, routing of user plane data to UPF(s), routing of control plane information to AMF, connection setup and release, scheduling and transmission (generated from AMF) of paging message, scheduling and transmission (generated from AMF or operating and maintenance (O&M)) of system broadcast information, measurement and measurement reporting configuration for mobility and scheduling, transport level packet marking on uplink, session management, support of network slicing, QoS flow management and mapping to data radio bearer, support of UE in inactive mode, distribution of NAS messages, NAS node selection, radio access network sharing, dual connectivity, and tight interworking between NR and E-UTRA.

The UE 101 may mean a user device. The user device may be referred to as a terminal, mobile equipment (ME), or mobile station (MS). Further, the user device may be a portable device, such as a laptop computer, mobile phone, personal digital assistant (PDA), smartphone, or multimedia device or may be a non-portable device, e.g., a personal computer (PC) or vehicle-mounted device.

The NEF 111 may provide a means to safely expose capabilities and services for, e.g., third party, internal exposure/re-exposure, application functions, and edge computing, provided by the 3GPP network functions. The NEF 111 may receive information (based on exposed capability(ies) of other NF(s)) from other NF(s). The NEF 111 may store the received information as structured data using a standardized interface to the data storage network function. The stored information may be re-exposed to other NF(s) and AF(s)by NEF and be used for other purposes, e.g., analysis.

The NRF 115 may support service discovery function. It may receive an NF discovery request from an NF instance and provide discovered NF instance information to the NF instance. Further, available NF instances and their supporting service may be maintained.

Meanwhile, although FIG. 1 illustrates an example reference model in which the UE 101 accesses one DN 110 using one PDU session for ease of description, the disclosure is not limited thereto.

The UE 101 may simultaneously access, e.g., two data networks (i.e., local and central) using multiple PDU sessions. In this case, two SMFs may be selected for different PDU sessions. However, each SMF may have the capability of controlling both the local and central UPFs in the PDU session.

Further, the UE 101 may simultaneously access, e.g., two (i.e., local and central) data networks provided in a single PDU session.

The NSSF 114 may select a set of network slice instances serving the UE 101. Further, the NSSF 114 may determine granted network slice selection assistance information (NSSAI) and may perform mapping to subscribed single-network slice selection assistance information (S-NSSAI), if necessary. Further, the NSSF 114 may determine the configured NSSAI and may perform mapping to subscribed S-NSSAIs, if necessary. Further, the NSSF 114 may determine the AMF set used to serve the UE or query the NRF 115 according to the configuration to thereby determine a list of candidate AMFs.

The NRF 115 may support service discovery function. It may receive an NF discovery request from an NF instance and provide discovered NF instance information to the NF instance. Further, available NF instances and their supporting service may be maintained.

In the 3GPP system, a conceptual link connecting NFs in the 5G system is defined as a reference point. Example reference points included in the 5G system architecture represented in FIG. 1 are provided as follows.
N1: the reference point between the UE and the AMF
N2: Reference point between (R)AN and AMF
N3: Reference point between (R)AN and UPF
N4: Reference point between SMF and UPF
N5: Reference point between PCF and AF
N6: Reference point between UPF and data network
N7: Reference point between SMF and PCF
N8: the reference point between the UDM and the AMF
N9: Reference point between two core UPFs
N10: Reference point between UDM and SMF
N11: Reference point between AMF and SMF
N12: Reference point between AMF and AUSF
N13: the reference point between UDM and authentication server function (AUSF)
N14: the reference point between two AMFs
N15: the reference point between PCF and AMF in non-roaming scenario and reference point between PCF in visited network and AMF in roaming scenario

In the following description, terminal may refer to the UE 101, and the terms “UE” and “terminal” may be interchangeably used. In this case, terminal may be appreciated as UE 101 unless defined otherwise.

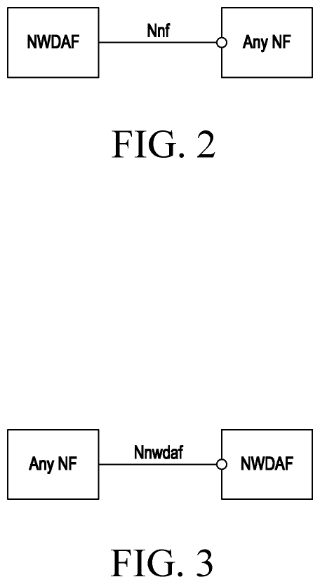

FIG. 2 is a view illustrating a network architecture and interface of a 5G system according to an embodiment of the disclosure. The network data analytics function (NWDAF) may collect data from any NF included in the core network. In this case, the NWDAF and the counterpart NF should belong to the same PLMN. An Nnf reference point may be used between the NWDAF and any NF.

FIG. 3 is a view illustrating a network structure and interface of a 5G system according to an embodiment of the disclosure. Any NF included in the core network may request network analytics information and an analytics logical function (AnLF) from the NWDAF. An Nnwdaf reference point may be used between the request NF (consumer NF) and the NWDAF. The request NF and the NWDAF for consuming analytics information should belong to the same PLMN.

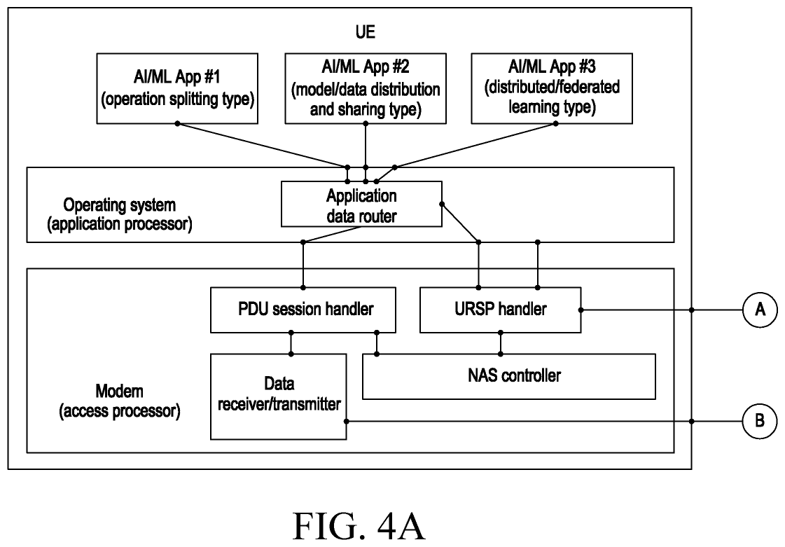

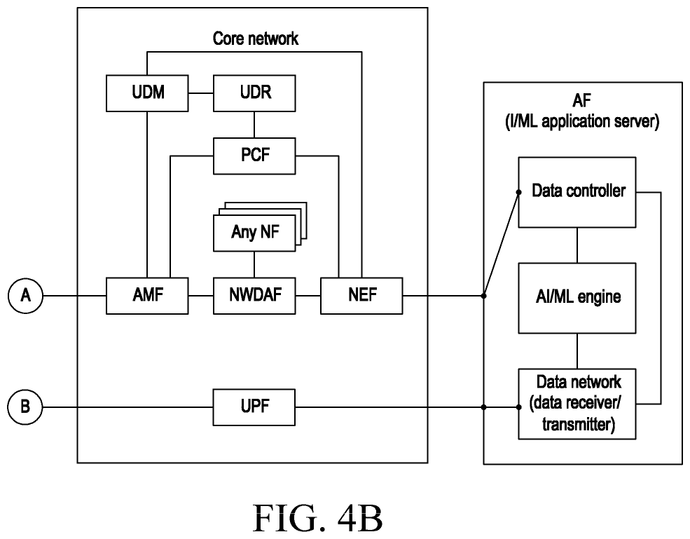

FIGS. 4A and 4B are views illustrating a network structure and an interface of a 5G system according to an embodiment of the disclosure. FIGS. 4A and 4B include the system described with reference to FIGS. 1 to 3, and the contents thereof may be omitted from the description of FIGS. 4A and 4B.

Referring to FIGS. 4A and 4B, the UE may be composed of an application layer, an operating system, and a modem. The UE may be connected to the core network through the control plane and the user plane. For the control plane, the UE may be connected to the AMF via the N1 interface through the RAN. For the user plane, the UE may be connected to the UPF through the RAN, and the RAN and UPF can be connected through the N3 interface. The UPF may be connected to the DN through an N6 interface.

The modem may operate on the connection processor. The modem may include a NAS controller, a URSP handler, a data receiver/transmitter, and a PDU session handler. The receiver of the modem may transfer data corresponding to the NAS message among the data received from the core network to the NAS controller. The NAS controller may write control plane data to be transmitted to the core network as a NAS message and provide it to the transmitter of the modem. Among various types of NAS messages received from the core network, the NAS controller may transfer the UE policy (including a URSP rule) and related information provided by the PCF to the UE to the URSP handler. The NAS controller may determine whether there is an existing PDU session to which the URSP rule is applied when the URSP handler specifies and indicates a URSP rule for any application and, if present, transmit/receive data through the PDU session and, if not, perform a procedure for establishing a new PDU session. The NAS controller may transfer information necessary for the management of the PDU session to the PDU session handler among various types of NAS messages received from the core network. The URSP handler may store the UE policy (including a URSP rule) and related information provided by the PCF to the UE or, when the core network requests the UE policy and related information stored in the UE, transmit it to the core network through the NAS controller. The URSP handler may receive information that enables the OS to directly or indirectly identify the application executed on the OS and may specify a URSP rule for the application from among one or more URSP rules received from the NAS controller. The OS is information that may directly or indirectly identify the application, and may use the application ID and/or the AI/ML operation type. The data receiver/transmitter may transmit uplink data to the core network (transmitter), or receive downlink data from the core network (receiver). The data receiver may transfer downlink data to the PDU session handler. The data transmitter may transmit the uplink data received from the PDU session handler to the core network.

The operating system may operate on the application processor. The OS may include an application data router. The application data router may transfer direct/indirect identification information (which may include application ID and AI/ML operation type) of the application to the URSP handler when data traffic occurs due to the execution of the application. Further, the application data router may provide the PDU session handler with data traffic that should be transmitted to the user plane path of the PDU session for application.

The application layer may be located above the OS. Applications may be present in the application layer. When a certain application is executed and data traffic occurs, the corresponding application traffic may be transferred to the OS. Further, an application ID may be provided to the application data router so that the application traffic may be identified from which application the application traffic was generated. There are various types of applications for the AI/ML service in the 5G system, and they may be classified according to the model transfer method. For example, according to the model transfer method, an AI/ML operation type of the application may be designated as follows:
Operation splitting type (hereinafter, Type #1 for convenience): corresponds to a type in which the AI/ML operation and/or AI/ML model may be split into one or more portions according to the AI/ML task to be performed by the UE and the environment of the UE, some of which are performed by the UE, and some others by the network device according to the computing capabilities of the UE and the network components (endpoints). The AI/ML server may transmit a portion of the AI/ML model, rather than the entire AI/ML model, to the UE and, in this case, the server may reduce the burden of data transmission. Even an UE that does not have sufficient computing capabilities for processing AI/ML data may be able to support the service.
Model/data distribution and sharing type (hereinafter, Type #2 for convenience): corresponds to a type that may adaptively select an AI/ML model according to the function of the UE. Since the size of the storage of the UE is limited, the UE may not download all AI/ML models from the network at once. Therefore, after distributing and storing the AI/ML model in network components (endpoints), the system may be configured to adaptively select the AI/ML model and download it from the corresponding endpoints according to the AI/ML task to be performed by the UE and the environment of the UE. A large amount of AI/ML model data may be downloaded to the UE. Generally, model downloading may be operated in a manner that allows for the downloading of large volumes of data during nighttime hours when the network is not congested, as real-time performance is not critical.
Distributed/federated learning type (hereinafter, Type #3 for convenience): corresponds to a type in which the cloud server learns the global model, the UEs download the global model and partially learns the local model, and the cloud server aggregates the results using the 5G uplink channel to update the global model again. A large amount of global model data may be downloaded to the UE, and a large amount of upload data traffic may frequently occur from the UE to the server.

The application supporting the AI/ML service may provide the above-described AI/ML operation type supported by the application to the OS when transferring the application traffic to the OS. For example, referring to FIGS. 4A and 4B, application #1 may provide an AI/ML operation type value indicating “operation splitting type”, application #2 may provide an AI/ML operation type value indicating “model/data distribution and sharing type”, and application #3 may provide an AI/ML operation type value indicating “distributed/federated learning type” to the OS.

Referring to FIGS. 4A and 4B, the AI/ML application server may be located in the trusted domain of the 5G core network or in the untrusted domain. When located in the untrusted domain, the AF corresponding to the AI/ML application server may be considered a network device located outside the 5G core network, and may communicate with other NFs in the core network through the NEF of the core network. When present in the trusted domain, the AF corresponding to the AI/ML application server may be considered a network device that is present inside the 5G core network, and may communicate with other NFs in the core network through or without the NEF.

The AF (AI/ML application server) may include a data collector, an AI/ML engine, and data network. The AI/ML engine may generate, transfer, and learn a model for the AI/ML service. The data collector may collect assistance information necessary for AI/ML operation from the 5G core network, and the collected information may be provided to the AI/ML engine. The data network may provide data of the operation result of the AI/ML engine to the UE (data transmitter), or may receive the result of the AI/ML operation of the UE (data receiver).

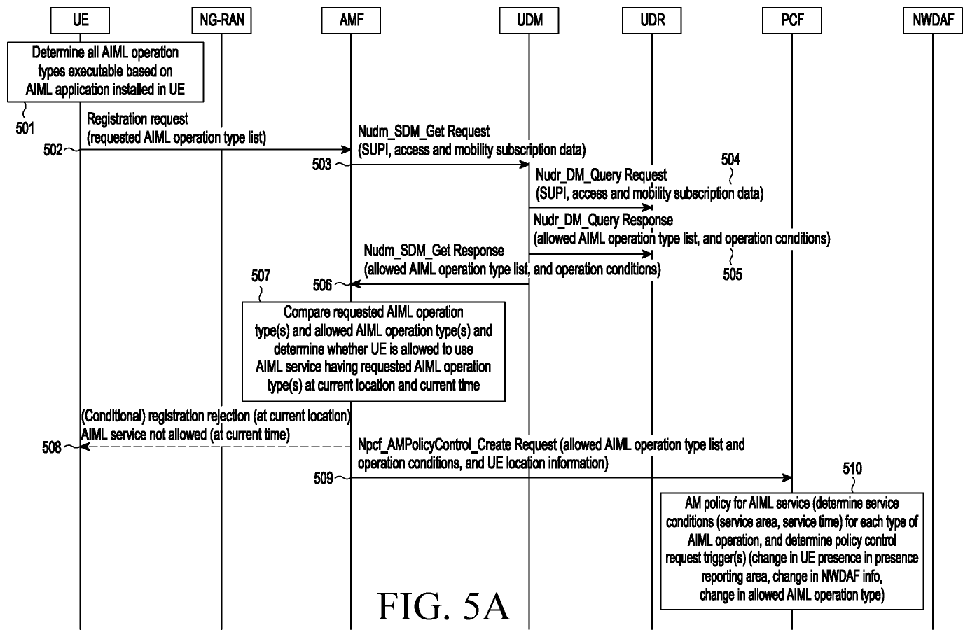

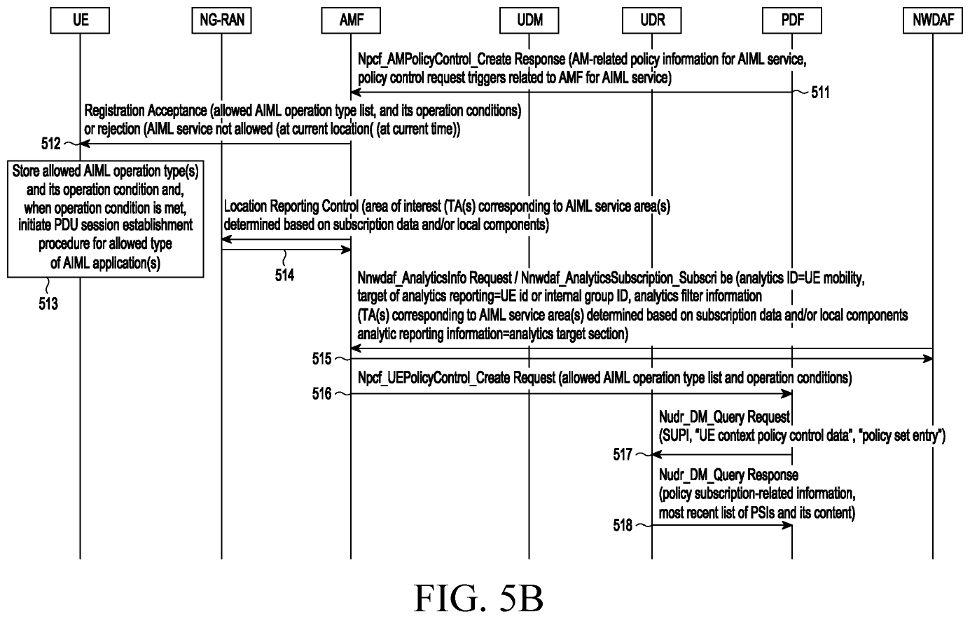

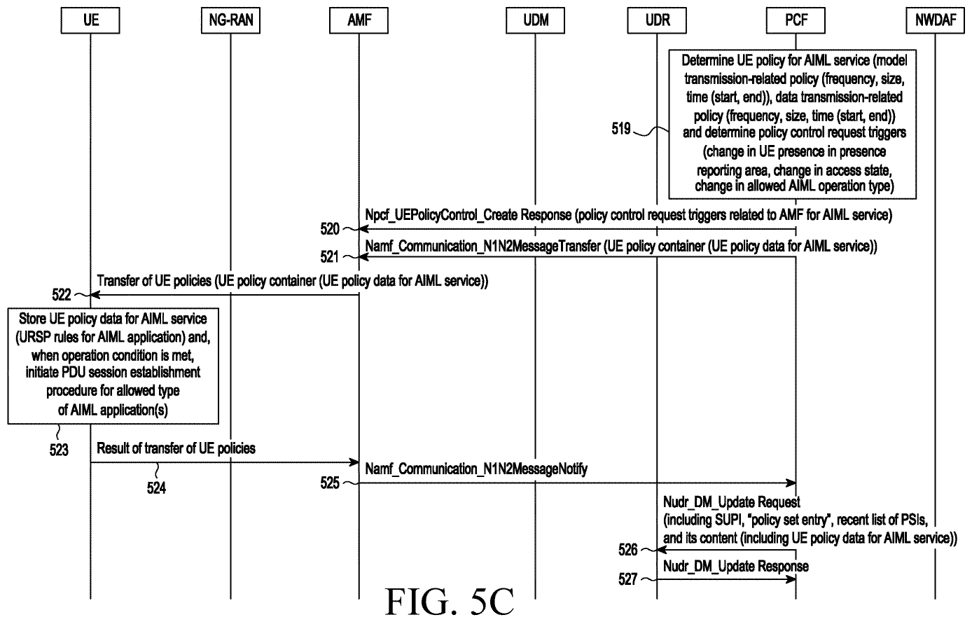

FIGS. 5A, 5B, and 5C are flowcharts illustrating a procedure related to providing network information for an AI/ML application in a 5G system according to an embodiment of the disclosure. More specifically, FIGS. 5A, 5B and 5C describe a method for authenticating the AI/ML operation type allowed for the UE during the registration procedure. FIGS. 5A, 5B, and 5C include the systems described with reference to FIGS. 1 to 4, and the contents thereof may be omitted from the description of FIGS. 5A, 5B, and 5C.
501. The UE may determine the AI/ML operation type(s) supported by the AI/ML application(s) installed on the UE. When any AI/ML application is installed on the UE, the application may inform the application data router of the AI/ML operation type it supports. The application data router may provide the same to the NAS controller (in this case, it may or may not go through the URSP handler).
502. The UE may transmit a registration request to the AMF. The UE may provide the AMF with a list of AI/ML operation type(s) of AI/ML application(s) installed on the UE recognized in step 501 as a list of requested AIML operation types.
503. The AMF may request, from the UDM, subscriber information necessary for the registration and mobility management of the UE including subscriber information related to AI/ML operation. The AMF may use an Nudm_SDM_Get Request message and may provide a subscription permanent identifier (SUPI) associated with the UE. If the AMF already stores the subscriber information related to AI/ML operation for the UE, steps 503 to 506 may be omitted.
504. The UDM may request, from the UDR, subscriber information necessary for the registration and mobility management of the UE. The UDM may use an Nudr_DM_Query Request message and may provide a SUPI.
505. The UDR may provide the UDM with subscriber information necessary for UE registration and mobility management including subscriber information related to AI/ML operation. The subscriber information related to the AI/ML operation may include a list of at least one AIML operation type allowed for the subscriber and at least one operation condition (list of allowed AIML operation types). The operation condition may include at least one of location and time. For example, for the subscriber indicated by the SUPI, the operation splitting type and model/data distribution and sharing type may be included in the allowed AIML operation type. Each allowed AIML operation types may be provided with the operation condition. For the UE located in a specific tracking area for the model/data distribution and sharing type of the two types, if there is a condition that the service may be used only in a specific time period, an operation condition including information for the allowed tracking area(s) in the location condition, and information for the start time and the end time in the time condition may be provided. The UDR may use an Nudr_DM_Query Response message.
506. The UDM may provide the AMF with subscriber information necessary for UE registration and mobility management including subscriber information related to AI/ML operation. The UDM may use an Nudm_SDM_Get Response message.
507. The AMF may compare the requested AIML operation type list received from the UE in step 502 with the allowed AIML operation type list received from the UDM in step 506 to determine the type allowed in the network among the types requested by the UE and, after identifying whether the allowed type additionally has an allowance condition, determine whether it may operate at the current location and/or current time.
508. The AMF may reject the UE's registration request when none of the operation types included in the requested AIML operation type list provided by the UE in step 502 are included in the allowed AIML operation type list or when the operation condition is not met as a result of the determination in step 507. The AMF may provide the UE that the AIML service is not allowed, the AIML service is not allowed at the current location, or the AIML service is not allowed at the current time for reasons of rejection. When step 508 is executed, the steps after step 508 of FIGS. 5A, 5B, and 5C may not be executed.
509. When it is determined that the UE is allowed to use the AIML service (at the current location and/or the current time) as the requested AIML operation type as a result of the determination in step 507, the AMF may request an AM policy considering the allowed AIML operation type and the operation condition from the PCF. The AMF may use an Npcf_AMPolicyControl_Create Request message, and may provide the PCF with the list of allowed AIML operation types and operation conditions determined in step 507. The AMF may provide location information about the UE together when there is a condition related to the location in the operation condition.
510. The PCF may determine an AM policy for the AIML service based on the information received from the AMF in step 509. Further, the PCF may determine the policy control request trigger (PCRT) for AMF so that it may monitor whether the AIML operation type and condition are normally met. The PCRT for AMF may include at least one of a Change of UE Presence in Presence Reporting Area, an NWDAF Info Change, and a Change of allowed AIML operation type. The Change of UE Presence in Presence Reporting Area corresponds to a PCRT that, when a change occurs in the information about whether the UE is located in the location area designated by the location condition among the operation locations, or not, or whether it may not be known, allows the AMF to report the same to the PCF. The NWDAF Info change corresponds to a PCRT that, when collecting information related to the corresponding AIML application from the NWDAF, allows the AMF to report any change in the NWDAF information in charge of the same to the PCF. The Change of allowed AIML operation type corresponds to a PCRT that, when a change occurs in the allowed AIML operation type or the operation condition, allows the AMF to report the same to the PCF. For example, the AMF that receives the PCRT may request the UDM to notify when a change occurs in the allowed operation type or the operation condition in the subscriber information and, when receiving a notification of occurrence of change from the UDM, report the occurrence of the change to the PCF.
511. The PCF may provide the AMF with the AM policy for the AIML service determined in step 510 and the PCRT related to the AMF for the AIML service. The PCF may use an Npcf_AMPolicyControl_Create Response message. The AMF may store AM policy information (which may include the AM policy and PCRT) received from the PCF and apply it to UE registration and mobility management.
512. The AMF may accept the UE's registration request when all of the registration conditions including registration conditions related to the AIML operation type and condition subscriber information are met. The AMF may transmit a registration accept message to the UE, and may provide a list of allowed AIML operations and operation conditions determined in step 507. The AMF may reject the UE's registration request when none of the operation types included in the requested AIML operation type list are included in the allowed AIML operation type list or when the operation condition is not met by the information received from other NF, RAN, and/or UE after step 507 and before step 512. In this case, a reason for rejection such as step 508 may be provided.
513. The UE may store the list of allowed AIML operation types and operation conditions received from the AMF, and may request the establishment of a PDU session for AIML application when the conditions are met. Referring to the descriptions of FIGS. 4A and 4B, the NAS controller may provide the list of allowed AIML operation types and operation conditions received from the AMF to the URSP handler or OS (which may be the application data router or other component of the OS) to store them. When a certain AI/ML application is executed and application traffic occurs, the URSP handler and/or OS may determine whether the AI/ML operation type value provided by the application is included in the allowed AIML operation type list received from the AMF, and when included, determine whether the operation condition is met, and when it is determined that the operation condition is met, perform processing related to the PDU session for the application.
514. The AMF may request the NG-RAN (e.g., the base station) to report the location information about the UE when it is necessary to monitor the location information about the UE among the operation conditions received in steps 507 and/or 511. For example, the AMF may transmit a location reporting control request message to the NG-RAN, which may provide information about the target area where the location information about the UE should be monitored. For example, among the operation conditions included in the subscriber information received in step 506, the identifier of the tracking area(s) corresponding to the AIML service area or the tracking area(s) corresponding to the AIML service area set in the AMF may be provided as a portion of the area of interest. The NG-RAN may report UE presence status (e.g., located, not located, unknown) or UE location information to the AMF in the area of interest. When the location information about the UE is provided, the location information about the UE may include cell ID, TAI, PLMN ID, and country information. The period, accuracy, etc. of the report may follow the request of the AMF.
515. The AMF may request the NWDAF to collect and analyze the mobility information about the UE when it is necessary to monitor the location information about the UE among the operation conditions received in steps 507 and/or 511. When requesting the NWDAF to collect and analyze mobility information about the UE, AMF may use an Nnwdaf_AnalyticsInfo Request or Nnwdaf_AnalyticsSubscription_Subscribe message, and may provide “UE mobility” as the value of the analytics ID, the UE ID or internal group ID as the value of target of analytics reporting, the area of interest as the analytics filter information, and the target period of information and analysis as the analytics reporting information. The area of interest may provide information about the target area in which the mobility information about the UE is to be monitored. For example, among the operation conditions included in the subscriber information received in step 506, the identifier of the tracking area(s) corresponding to the AIML service area or the tracking area(s) corresponding to the AIML service area set in the AMF may be provided as a portion of the area of interest. The NWDAF may collect and analyze the mobility information about the UE in the area of interest from the network according to the request from the AMF, and may provide the collected information and/or analytics information to the AMF. When the NWDAF provides the location information about the UE to the AMF, the location information about the UE may include cell ID, TAI, PLMN ID, and country information. The NWDAF may use an Nnwdaf_AnalyticsInfo Response or Nnwdaf_AnalyticsSubscription_Notify message.
516. The AMF may request, from the PCF, the UE policy considering the allowed AIML operation type and operation condition. The AMF may use an Npcf_UEPpolicyControl_Create Request message, and may provide the PCF with the list of allowed AIML operation types and operation conditions determined in step 507.
517. The PCF may request, from the UDR, subscriber information related to the policy and/or the most recent UE policy information transmitted to the UE. When requesting information from the UDR, the PCF may use an Nudr_DM_Query Request message and provide “Policy Data” as the data set value, “UE context policy control data” (value for requesting subscriber information related to the policy) as the data subset value, and/or “Policy Set Entry data” (value for requesting the most recent UE policy information transmitted to the UE), and the SUPI as the UE identifier.
518. The UDR may provide the PCF with information according to the request in step 517. When providing information to the PCF, the UDR may use an Nudr_DM_Query Response message, and may provide subscriber information related to the policy, and/or the most recent UE policy information transmitted to the UE.
519. The PCF may determine the UE policy for the AIML service based on the information received from the AMF in step 516 and the information received from the UDR in step 518. The UE policy for the AIML service may include at least one of a policy related to AI/ML model transfer and a policy related to AI/ML data transfer, and each may include at least one of a transmission frequency, a transmission size, and a transmission execution time (which may include a start time and an end time). The policy related to the AI/ML model transfer and the policy related to the AI/ML data transfer may be included in the URSP rule. Further, the PCF may determine the policy control request trigger (PCRT) for AMF so that it may monitor whether the AIML operation type and condition are normally met. The PCRT for AMF may include at least one of a Change of UE Presence in Presence Reporting Area, an NWDAF Info Change, and a Change of allowed AIML operation type. Each may follow the steps described in step 510.
520. The PCF may provide the AMF with the PCRT related to the AMF for the AIML service determined in step 519. The PCF may use an Npcf_UEPolicyControl_Create Response message. The AMF may store the PCRT received from the PCF and apply it to UE registration and mobility management.
521. The PCF may provide the AMF with a UE policy container including the UE policy for the AIML service determined in step 519. The PCF may use an Namf_Communication_N1N2MessageTransfer message.
522. The AMF may transfer the UE policy container received in step 521 to the UE.
523. The UE may store and process the UE policy for the received AIML service. Referring to the description of FIGS. 4A and 4B, the NAS controller may transfer the URSP rule to the URSP handler. Further, if a certain AI/ML application is executed, the application provides the operation type to the application data router, which may transfer it to the URSP handler. The URSP handler may specify a URSP rule in which the operation type provided by the application matches the operation condition corresponding to the UE's current location and/or current time. The URSP handler may determine whether a PDU session for the corresponding URSP rule is already present or whether a new PDU session should be established, and may allow the NAS controller to start the PDU session establishment procedure or the PDU session modification procedure, according to the result of the determination.
524. The UE may transfer a result (e.g., success or failure) of the UE policy transfer to the AMF.
525. The AMF may transfer information related to the result of the UE policy transfer to the PCF.
526. The PCF may store or update UE policy data in the UDR by comparing the most recent UE policy information (which may include the UE policy for the AIML service) transmitted to the UE, received from the UDR in step 517, and the most recent UE policy information (which may include the UE policy for the AIML service) determined by the PCF and transmitted to the UE in step 519. The PCF may use an Nudr_DM_Update Request message, and provide “Policy Data” as the value of the data set, “Policy Set Entry data” as the value of the data subset, the most recent UE policy information transmitted to UE (which may include the UE policy for the AIML service), and SUPI as the UE identifier. The most recent UE policy information transmitted to the UE may be constituted of one or more policy set identifiers (PSIs) and a list of contents (policy data).
527. The UDR may respond to the PCF with the result of the storage or update of UE policy data, and may use an Nudr_DM_Update Response message.

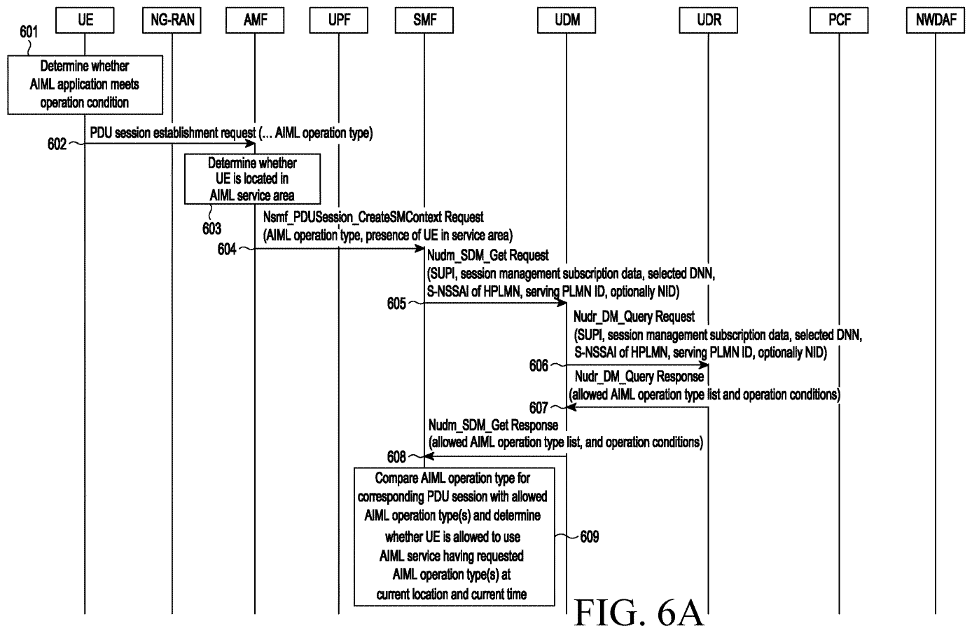

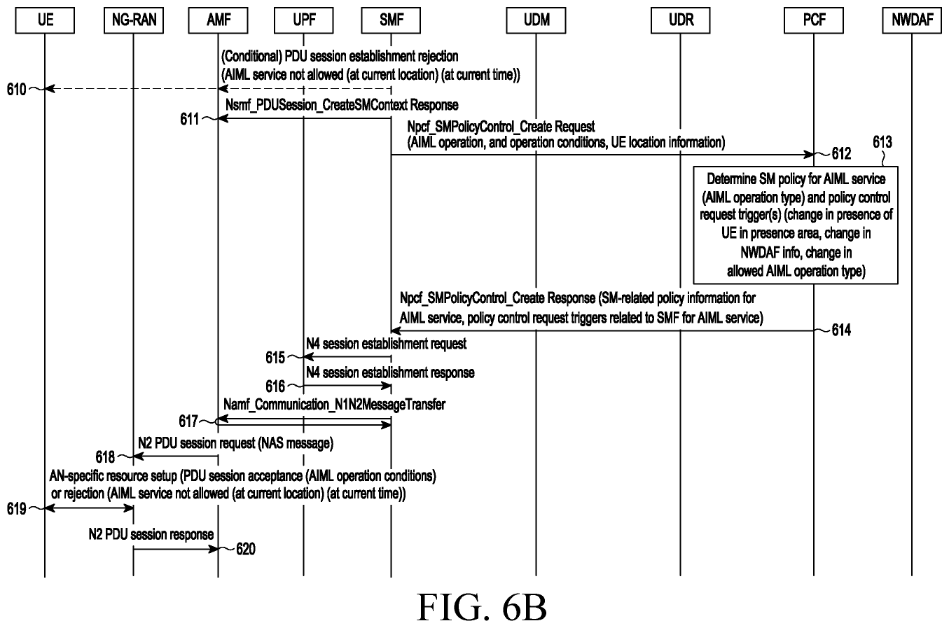

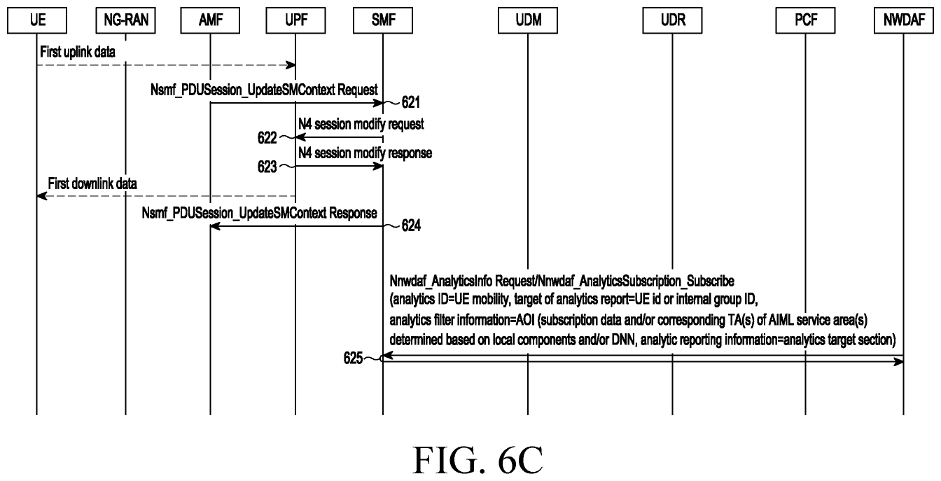

FIGS. 6A, 6B, and 6C are flowcharts illustrating a procedure related to providing network information for an AI/ML application in a 5G system according to an embodiment of the disclosure. More specifically, FIGS. 6A, 6B, and 6C describe a method for authenticating the AI/ML operation type allowed for the UE during the PDU session establishment procedure. FIGS. 6A, 6B, and 6C include the system described with reference to FIGS. 1 to 5C, and the contents thereof may be omitted from the description of FIGS. 6A, 6B, and 6C.
601. The UE may determine whether the executed AI/ML application meets the allowed operation type and operation condition received from the network in the registration procedure described with reference to FIGS. 5A, 5B, and 5C, and may determine whether a new PDU session should be established for the application. For example, the operation of step 523 of FIG. 5C may be performed.
602. When it is determined in step 601 that a new PDU session should be established for AI/ML application, the UE may transmit a PDU session establishment request to the AMF. When sending the request, the UE may provide at least one of DNN for PDU session, S-NSSAI, and AI/ML operation type of the corresponding AI/ML application.
603. For the AI/ML operation type provided by the UE in step 602, the AMF may identify the list of allowed operation types and operation conditions stored during the registration procedure described in the drawings to determine whether the UE is currently located in the AI/ML service area designated by the operation condition of the operation type. For example, if the AMF stores the allowed operation type and operation condition that the model/data distribution and sharing type are allowed in the TA1 and TA2 areas in the registration procedure of the UE, the AMF may determine whether the UE is currently located in TA1 or TA2. As described in steps 514 and 515 of FIG. 5B, the AMF may receive location information about the UE from the NG-RAN or NWDAF, or other NF, or UE. In this case, the location information about the UE may include cell ID, TAI, PLMN ID, and country information. The AMF may reject the PDU session establishment request when the UE is not currently located in the AI/ML service area designated by the operation condition of the corresponding operation type, or when the current time is not the time designated by the operation condition. The AMF may provide the UE that the AIML service is not allowed, the AIML service is not allowed at the current location, or the AIML service is not allowed at the current time for reasons of rejection.
604. When it is determined that the UE is located in the AI/ML service area, the AMF may request the SMF to establish a PDU session. When sending the request, the AMF may use an Nsmf_PDUSession_CreateSMContext Request message, which may include at least one of the AIML operation type received in step 602, the operation condition provided by the UE or stored by the AMF, whether the UE is located in the AIML service area, determined in step 603 (e.g., located in the service area, not located, or unknown), and location information about the UE.
605. The SMF may request, from the UDM, subscriber information necessary for session management. The AMF may use an Nudm_SDM_Get Request message and may provide at least one of the SUPI, “Session Management Subscription data” as the value of the type of the subscriber information requested, the selected DNN (which is the DNN requested by the UE and may be provided to the AMF in step 602, and may be transferred to the SMF by the AMF in step 604), the S-NSSAI of the HPLMN (which is the S-NSSAI requested by the UE, and may be provided to the AMF in step 602, and may be transferred to the SMF by the AMF in step 604), Serving PLMN ID, and NID. If the SMF already stores the subscriber information for session management, steps 605 to 608 may be omitted.
606. The UDM may request, from the UDR, subscriber information necessary for session management. The UDM may use an Nudr_DM_Query Request message and may provide at least one of the SUPI, “Session Management Subscription data” as the value of the type of the subscriber information requested, the selected DNN (which is the DNN requested by the UE and may be provided to the AMF in step 602, and may be transferred to the SMF by the AMF in step 604), the S-NSSAI of the HPLMN (which is the S-NSSAI requested by the UE, and may be provided to the AMF in step 602, and may be transferred to the SMF by the AMF in step 604), Serving PLMN ID, and NID.
607. The UDR may provide the UDM with subscriber information necessary for session management including the subscriber information related to the AI/ML operation. The subscriber information related to the AI/ML operation may include the AIML operation type allowed for the subscriber and the list (allowed AIML operation type list) of the operation condition, and the description of step 505 of FIG. 5A may apply. The UDR may use an Nudr_DM_Query Response message.
608. The UDM may provide the SMF with subscriber information necessary for session management including the subscriber information related to the AI/ML operation. The UDM may use an Nudm_SDM_Get Response message.
609. The SMF may compare the AIML operation type, the operation condition, and/or whether the UE is located in the AIML service area, received from the AMF in step 604, with the allowed AIML operation type and operation condition list received from the UDM in step 608, determining whether operation is possible at the current location and/or current time of the UE. When it is determined that the AIML application of the requested PDU session is operable at the current location and/or current time of the UE, step 610 below may be omitted.
610. When the SMF determines that the AIML application of the requested PDU session is not operable at the current location and/or current time of the UE in step 609, the SMF may reject the PDU session establishment request. The SMF may provide the AMF that the AIML service is not allowed, the AIML service is not allowed at the current location, or the AIML service is not allowed at the current time for reasons of rejection, and the AMF may transfer the same to the UE.
611. When the SMF determines that the AIML application of the requested PDU session is operable at the current location and/or current time of the UE, the SMF may send a response to the request of step 604 to the AMF. The SMF may use an Nsmf_PDUSession_CreateSMContext Response message.
612. When the SMF determines that the AIML application of the requested PDU session is operable at the current location and/or current time of the UE, the SMF may request an SM policy considering the AIML operation type and the operation condition from the PCF. The SMF may use an Npcf_SMPolicyControl_Create Request message and may provide the PCF with at least one of the AIML operation type, operation condition, information about whether the UE is located in the AIML service area, and location information about the UE, received from the AMF in step 604.
613. The PCF may determine an SM policy for the AIML service based on the information received from the SMF in step 612. Further, the PCF may determine the policy control request trigger (PCRT) for SMF so that it may monitor whether the AIML operation type and condition are normally met. The PCRT for SMF may include at least one of a Change of UE Presence in Presence Reporting Area, an NWDAF Info Change, and a Change of allowed AIML operation type. The Change of UE Presence in Presence Reporting Area corresponds to a PCRT that, when a change occurs in the information about whether the UE is located in the location area designated by the location condition among the operation locations, or not, or whether it may not be known, allows the SMF to report the same to the PCF. For example, when the value indicating whether the UE is located in the AIML service area, received from the AMF, differs from the value previously received from the AMF, the SMF receiving the PCRT may report, to the PCF, that a change has occurred. The NWDAF Info change corresponds to a PCRT that, when collecting information related to the corresponding AIML application from the NWDAF, allows the SMF to report any change in the NWDAF information in charge of the same to the PCF. The Change of allowed AIML operation type corresponds to a PCRT that, when a change occurs in the allowed AIML operation type or the operation condition, allows the SMF to report the same to the PCF. For example, the SMF that receives the PCRT may request the UDM to notify when a change occurs in the allowed operation type or the operation condition in the subscriber information and, when receiving a notification of occurrence of change from the UDM, report the occurrence of the change to the PCF.
614. The PCF may provide the SMF with the SM policy for the AIML service determined in step 613 and the PCRT related to the SMF for the AIML service. The PCF may use an Npcf_SMPolicyControl_Create Response message. The SMF may store SM policy information (which may include the SM policy and PCRT) received from the PCF and apply it to session management.
615. The SMF may request an N4 session from the UPF and may perform a procedure related to allocation of user plane resources (which may include, e.g., determination of CN N3 tunnel information).
616. The UPF may perform a procedure related to the allocation of user plane resources and respond to the N4 session request of the SMF.
617. The SMF may accept the UE's PDU session establishment request when all of the PDU session establishment conditions including registration conditions related to the AIML operation type and condition subscriber information are met. The SMF may provide the AMF with the information required for the UE and RAN to complete the PDU session establishment. The SMF may reject the PDU session establishment request of the UE when the AIML operation type and condition are not met based on the information provided from other NF, RAN and/or UE after step 609 and before step 617. In this case, a reason for rejection such as step 610 may be provided. The SMF may use an Namf_Communication_N1N2MessageTransfer message. The AMF may provide a response message (e.g., an acknowledgement message) to the Namf_Communication_N1N2MessageTransfer message received by the SMF.
618. The AMF may request an N2 PDU session from the RAN. The AMF may provide the RAN with information related to access network resource allocation and a NAS message to be transferred to the UE.
619. The RAN may perform resource configuration for an access network between the UE and the RAN. The RAN may transfer the NAS message to the UE, which may include the PDU session accept message or the PDU session reject message provided by the SMF in step 617. The UE may provide the result of the message reception to the RAN.
620. The RAN may send a response to the N2 PDU session request to the AMF. For example, it may include providing AN N3 tunnel information. After step 620, uplink data generated from the UE may be transmitted to the UPF via the RAN through the N3 tunnel.
621. The AMF may transfer the information received from the RAN to the SMF in step 620.
622. The SMF may transfer the information received in step 621 to the UPF.
623. The UPF may respond to information transfer of the SMF. For example, the UPF may store the AN N3 tunnel information and complete the configuration of the N3 tunnel. After step 623, downlink data generated from the DN may be transmitted to the UE via the RAN through the N3 tunnel. In this case, the DN may be the data transmitter of the AI/ML application server described with reference to FIGS. 4A and 4B.
624. The SMF may respond to the AMF.
625. The SMF may request the NWDAF to collect and analyze the mobility information about the UE when it is necessary to monitor the location information about the UE among the AIML operation conditions. When requesting the NWDAF to collect and analyze mobility information about the UE, SMF may use an Nnwdaf_AnalyticsInfo Request or Nnwdaf_AnalyticsSubscription_Subscribe message, and may provide “UE mobility” as the value of the analytics ID, the UE ID or internal group ID as the value of target of analytics reporting, the area of interest as the analytics filter information, and the target period of information and analysis as the analytics reporting information. The area of interest may provide information about the target area in which the mobility information about the UE is to be monitored. For example, among the operation conditions included in the subscriber information received in step 604 or received from the UDM in step 608 or included in the SM policy received in step 614, the identifier of the tracking area(s) corresponding to the AIML service area or the tracking area(s) corresponding to the AIML service area set in the SMF may be provided as a portion of the area of interest. The NWDAF may collect and analyze the mobility information about the UE in the area of interest from the network according to the request from the SMF, and may provide the collected information and/or analytics information to the SMF. When the NWDAF provides the location information about the UE to the SMF, the location information about the UE may include cell ID, TAI, PLMN ID, and country information. The NWDAF may use an Nnwdaf_AnalyticsInfo Response or Nnwdaf_AnalyticsSubscription_Notify message.

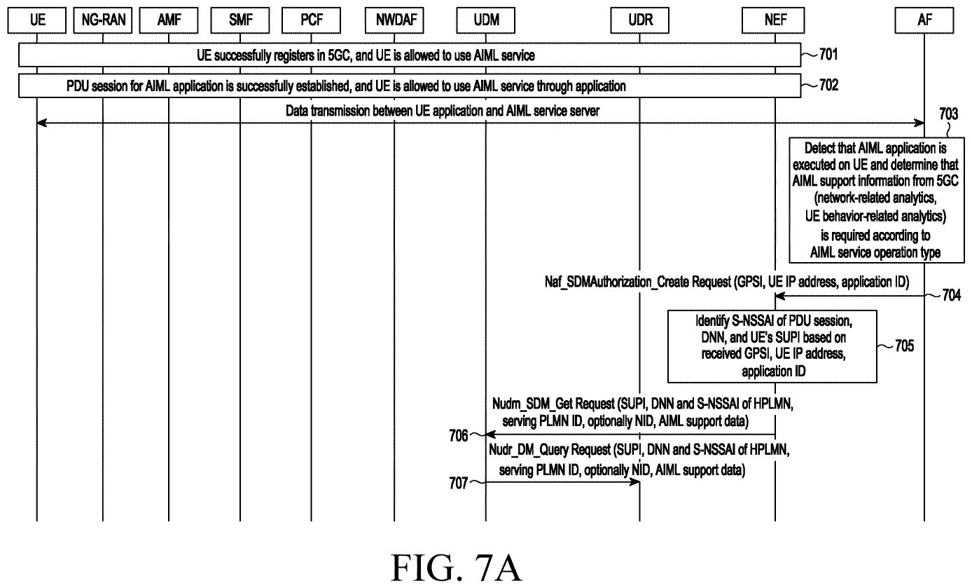

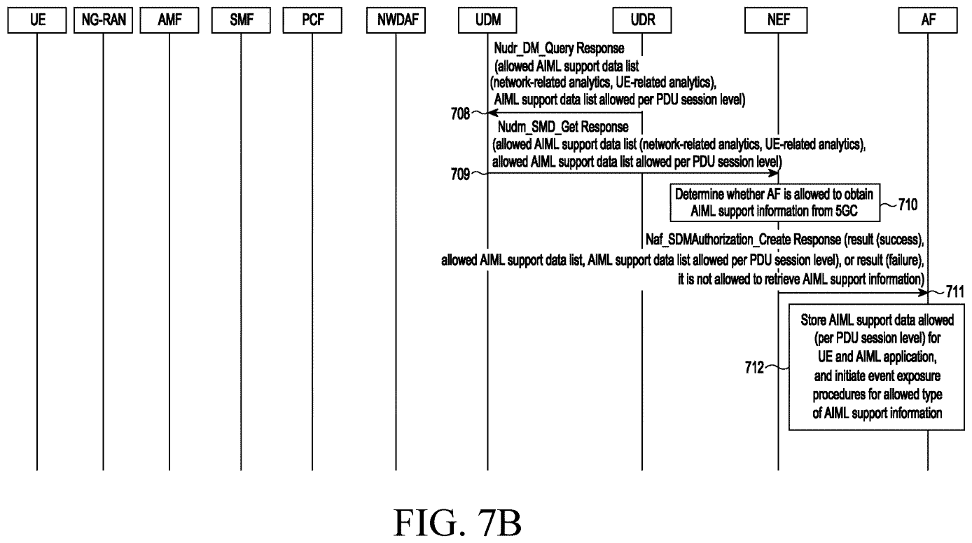

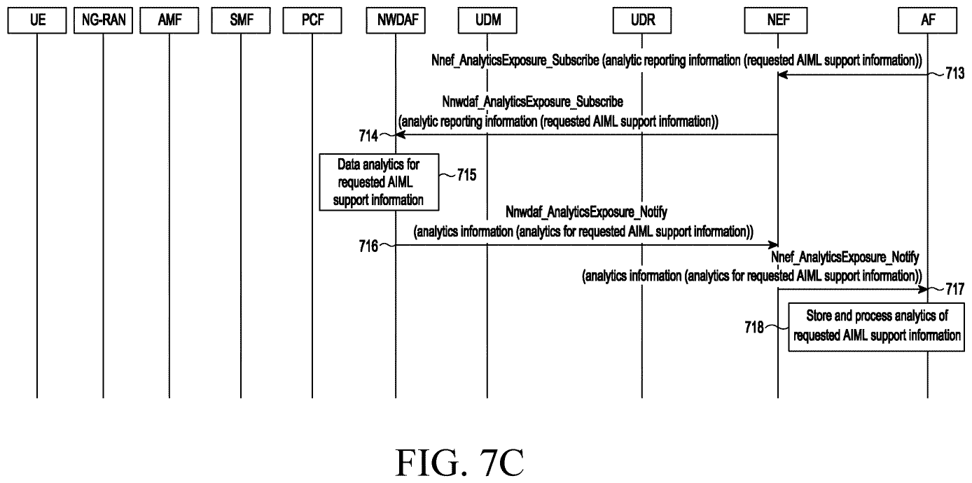

FIGS. 7A, 7B, and 7C are flowcharts illustrating a procedure related to providing network information for an AI/ML application in a 5G system according to an embodiment of the disclosure. More specifically, FIGS. 7A, 7B, and 7C describe a method for authenticating the AI/ML assistance information allowed for the AF during the AF subscriber information access authentication procedure. FIGS. 7A, 7B, and 7C include the system described with reference to FIGS. 1 to 6C, and the contents thereof may be omitted from the description of FIGS. 7A, 7B, and 7C.
701. According to the procedure described with reference to FIGS. 5A, 5B, and 5C, the 5G core network may complete the registration procedure for the UE allowing the use of the AIML service.
702. According to the procedures described with reference to FIGS. 6A, 6B, and 6C, the 5G core network may complete the procedure for establishing a PDU session for the application when the UE meets the operation type and operation condition capable of using the AIML application. The AIML application of the UE and the AIML server of the AF may transmit/receive data.
703. The AF may recognize that the AI/ML application has been executed in the UE, and may determine whether AI/ML assistance information should be provided from the 5G core network for the service of the AI/ML application. For example, the AI/ML assistance information that may be provided from the 5G core network may include network-related collection/analytics information and UE behavior-related collection/analytics information, and necessary information may be determined according to the operation type and/or operation condition of the AI/ML application.
704. The AF may request the NEF to authenticate the type of AI/ML assistance information allowed to be provided from the 5G core network. In this case, the AF may be a data collector of the AI/ML application server described with reference to FIGS. 4A and 4B. The AF may use an Naf_SDMAuthorization_Create Request message, and may include at least one of a GPSI, a UE IP address, and an application ID.
705. The NEF may identify the UE's identifier and the PDU session for the application service provided by the AF to the UE based on the information received from the AF in step 705. For example, the NEF may determine the SUPI mapped to the GPSI received from the AF, and determine the PDU session ID using the UE IP address and application ID.
706. The NEF may request subscriber information related to AIML assistance data from the UDM. The NEF may use an Nudm_SDM_Get Request message, and may provide at least one of the SUPI, “AIML assistance data” as the value of the type of the subscriber information requested, DNN, S-NSSAI of HPLMN, serving PLMN ID, NID, PDU session ID, application ID, and AF ID. The DNN and the S-NSSAI of the HPLMN may correspond to the DNN and the S-NSSAI of the PDU session identified in step 705. If the NEF already stores the subscriber information related to AIML assistance data, steps 706 to 709 may be omitted.
707. The UDM may request subscriber information related to AIML assistance data from the UDR. The UDM may use an Nudr_DM_Query Request message, and may provide at least one of the SUPI, “AIML assistance data” as the value of the type of the subscriber information requested, DNN, S-NSSAI of HPLMN, serving PLMN ID, and NID. The DNN and the S-NSSAI of the HPLMN may correspond to the DNN and the S-NSSAI of the PDU session identified in step 705. If the UDM already has the subscriber information related to AIML assistance data, steps 707 to 708 may be omitted.
708. The UDR may provide subscriber information related to AIML assistance data to the UDM. The subscriber information related to the AIML assistance data may include at least one of a list of AIML assistance data allowed for the AIML application or AF and a list of AIML assistance data allowed for the PDU session set for the AIML application. The list of allowed AIML assistance data may include a list of collection/analysis data types related to the network and/or a list of collection/analysis data types related to UE behavior. The UDR may use an Nudr_DM_Query Response message.
709. The UDM may provide subscriber information related to AIML assistance data to the NEF. The UDM may use an Nudm_SDM_Get Response message.
710. The NEF may determine whether there is AI/ML assistance information allowed for the AF, based on the information received in step 709.
711. The NEF may provide, as the result of authentication, the type of AI/ML assistance information (allowed AI/ML assistance data) allowed to receive the result of the determination in step 710 from the 5G core network requested by the AF in step 704. For example, if there is any AI/ML assistance information allowed for the AF in step 710, the NEF may provide the AF with the list of allowed AIML assistance data received from the UDM in step 709, along with the result information indicating that the authentication has succeeded. If there is no AI/ML assistance information allowed for the AF in step 710, the NEF may provide a reason for failure, along with the result information indicating that authentication has failed, and the reason for failure may include, e.g., obtaining/providing AIML assistance information being not allowed.
712. The AF may store and process the list of allowed AI/ML assistance information (which may include the list of allowed AI/ML assistance information at the PDU session level) received in step 711. The AF may initiate an event exposure procedure for the AI/ML assistance information included in the list of allowed AI/ML assistance information.
713. The AF may request, from the NEF, the AI/ML assistance information necessary for the service of the AI/ML application. In this case, the requested AI/ML assistance information may be information included in the list of allowed AI/ML assistance information received in step 712. The AF may use an Nnef_AnalyticsExposure_Subscribe message and indicate that it is requesting analytic reporting information, and the target for the request may be the requested AIML assistance information.
714. The NEF may transfer the request of step 713 to the NWDAF. The NEF may use an Nnwdaf_AnalyticsExposure_Subscribe message and indicate that it is requesting analytic reporting information, and the target for the request may be requested AIML assistance information.
715. The NWDAF may collect and analyze information related to the requested AIML assistance information according to the request of step 714.
716. The NWDAF may provide the NEF with the results of collection and analysis of information related to the requested AIML assistance information. The NWDAF may use an Nnwdaf_AnalyticsExposure_Notify message and indicate that it provides analytic reporting information, which may include collection and analytics information related to the requested AIML assistance information.
717. The NEF may provide the AF with the results of the collection and analysis of information related to the requested AIML assistance information. The AF may use an Nnef_AnalyticsExposure_Notify message and indicate that it provides analytic reporting information, which may include collection and analytics information related to the requested AIML assistance information.
718. The AF may store and process collection and analytics information related to the requested AIML assistance information. Referring to FIGS. 4A and 4B, the data collector of the AI/ML application server may store the received information and provide the same to the AI/ML engine to assist the model and data learning and data generation of the server.

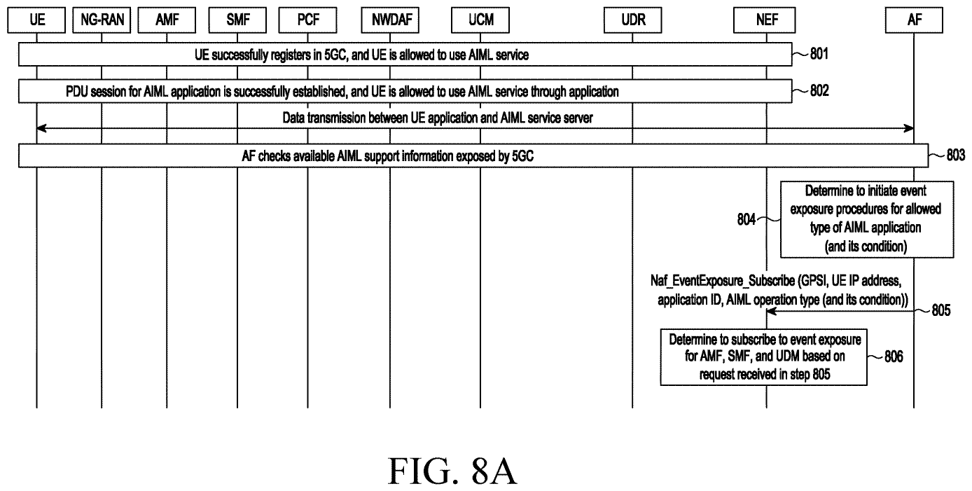

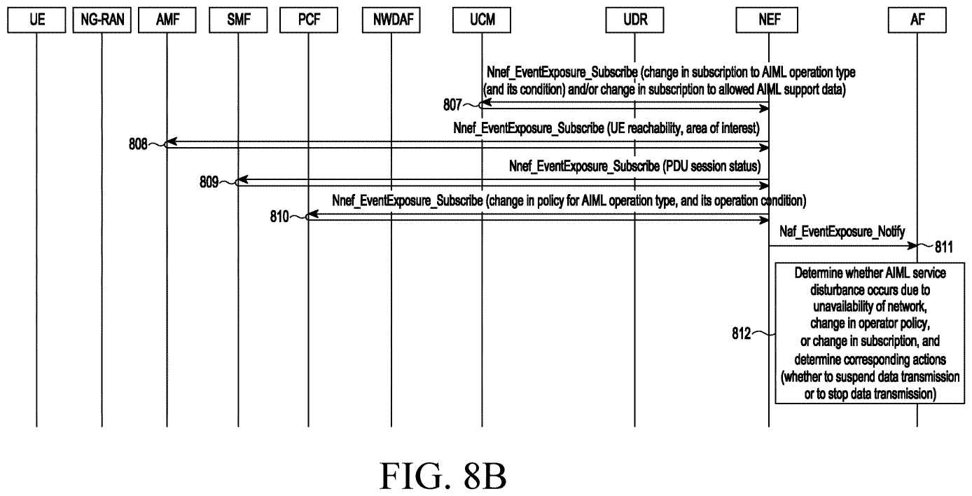

FIGS. 8A and 8B are flowcharts illustrating a procedure related to providing network information for an AI/ML application in a 5G system according to an embodiment of the disclosure. More specifically, FIGS. 8A and 8B describe a method for providing information to an AF during an event exposure procedure of a core network. FIGS. 8A and 8B include the system described with reference to FIGS. 1 to 7C, and the contents thereof may be omitted from the description of FIGS. 8A and 8B.
801. According to the procedure described with reference to FIGS. 5A, 5B, and 5C, the 5G core network may complete the registration procedure for the UE allowing the use of the AIML service.
802. According to the procedures described with reference to FIGS. 6A, 6B, and 6C, the 5G core network may complete the procedure for establishing a PDU session for the application when the UE meets the operation type and operation condition capable of using the AIML application. The AIML application of the UE and the AIML server of the AF may transmit/receive data.
803. According to the procedure described with reference to FIGS. 7A, 7B, and 7C, the AF may authenticate AI/ML assistance information that may be provided from the 5G core network, and may request, from the core network, the collection and analytics information for the allowed AI/ML assistance information.
804. The AF may initiate an event exposure procedure related to the operation type and operation condition when the operation of the AI/ML engine and/or the data receiver/transmitter may vary according to the operation type and operation condition of the AI/ML application in the UE.
805. The AF may request the NEF to inform when an event related to the operation type and operation condition of the AI/ML application occurs. An Naf_EventExposure_Subscribe message may be used. At least one of GPSI, SUPI, and UE IP address may be included as the identifier of the event exposure target UE and, as the identifier of the target for the event, at least one of the application ID, AIML operation type (which may include the operation condition), and AF ID may be included.
806. The NEF may identify the event exposure target UE based on the request information about the AF in step 805, and may identify the target for the event. The NEF may determine a network entity(ies) that may detect a change in the AIML operation type and/or operation condition of the AIML application which is the target for the event, a change related to the subscriber information or the PDU session for the corresponding AIML application of the UE which is the event exposure target, and a change in the AIML assistance data allowed for the AF or the AIML application which is the target for the event. For example, when a location operation condition is included in the target for the event, it may be determined that the network entity that may detect the change related to the mobility of the UE is the AMF.
807. According to the result of the determination in step 806, the NEF may request the UDM to notify when a change occurs in the subscriber information related to the AIML operation type and/or the operation condition of the AIML application of the UE and/or the subscriber information related to the AIML assistance data allowed for the AF or the AIML application. The NEF may use an Nnef_EventExposure_Subscribe message.
808. According to the result of the determination in step 806, the NEF may request the AMF to notify when a change related to the mobility of the UE occurs. The information about the mobility of the UE may include at least one of the UE reachability (which may be a change in the connection state of the UE and/or the registration state of the UE), the area of interest (which may be a change in whether the UE is located in the service area of the AIML application). The NEF may use an Nnef_EventExposure_Subscribe message. The AMF may notify the NEF when a change occurs, and may use an Nnef_EventExposure_Notify message.
809. According to the result of the determination result in step 806, the NEF may request the SMF to notify when a change related to the session occurs. The information about the session may include a PDU session status (which may be a change in whether the PDN session is maintained). The NEF may use an Nnef_EventExposure_Subscribe message. The SMF may notify the NEF when a change occurs, and may use an Nnef_EventExposure_Notify message.
810. According to the result of the determination in step 806, the NEF may request the PCF to notify when a change related to the policy occurs. The information about the policy may include at least one of changes in AM policy, SM policy, and UE policy related to the AIML operation type and/or operation condition. The NEF may use an Nnef_EventExposure_Subscribe message. The PCF may notify the NEF when a change occurs, and may use an Nnef_EventExposure_Notify message.

When the NEF receives a response to the notification request in steps 807, 808, and 809, it may transfer it to the AF. The NEF may use an Naf_EventExposure_Notify message.
812. If the AF receives a notification of the occurrence of an event related to the operation type and operation condition of the AI/ML application in step 811, the cause of the event occurring in the communication between the UE and the AI/ML application server may be determined based thereon. For example, when the communication status between the AI/ML application server and the UE is not smooth, the AI/ML may determine whether the cause of the communication failure is a network problem, a change in subscriber information about the UE, or a change in allowable information for the application server based on the notification of the occurrence of the event in step 811. The AI/ML application server may determine that the problem of the core network is not the cause of the communication failure when not receiving the notification of step 811 or when determining based on the notification of step 811 and, in this case, determine whether there is a problem with the AI/ML engine, the data collector, and/or the data network. The AF may make a determination on data transmission according to the determination result. For example, when the session is released from the core network or when it is notified that the UE is in a non-connectable state, the AF may temporarily delay and buffer the transmission of downlink data. As another example, when notified that the corresponding AIML application is changed to be not allowed in the subscriber information in the core network, the AF may stop data transmission and terminate data processing for the UE.

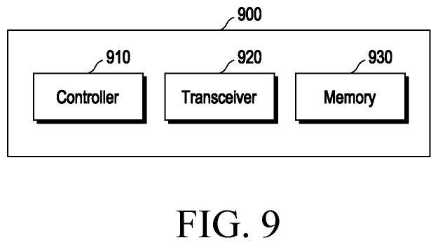

FIG. 9 is a block diagram illustrating a device according to an embodiment of the disclosure.

The device 900 may be referred to as an electronic device. The device 900 may implement any one of the entities described in the disclosure. For example, the device 900 may implement one of the UE and the plurality of NFs described with reference to FIGS. 1 to 8B. The device 900 may include a controller 910, a transceiver 920, and memory 930.

The controller 910 may be connected to other elements (e.g., the transceiver 920 and the memory 930) in the device 900 to control the operation of the other elements. The controller 910 may control the controller 910 itself and other elements of the device 900 to allow the device 900 to perform at least one operation. The operation of the device 900 may be interpreted as being substantially executed by the controller 910. The controller 910 may be implemented through at least one processor.

The transceiver 920 may include a circuit (i.e., communication circuitry) required for communication. The device 900 may communicate with another device through the transceiver 920. The transceiver 920 may support at least one of various radio access technologies such as long term evolution (LTE), LTE-Advanced (LTE-A), code division multiplex access (CDMA), orthogonal frequency division multiplexing (OFDM), Bluetooth, or the like, but is not limited thereto. The transceiver 920 may provide functions for communication to the device 900 using any known radio access techniques.

The memory 930 may be referred to as a ‘non-transitory computer-readable storage medium’ so as to be distinguished from a medium for transmitting information. The memory 930 may be implemented through at least one of random access memory (RAM), read-only memory (ROM), hard disk, CD-ROM, and solid state drive (SSD), but is not necessarily limited thereto and may be implemented through all types of storage media capable of storing and reading information. The memory 930 may store instructions executable by the controller 910. When instructions are executed by the controller 910, the controller 910 (or the device 900) may execute at least one of the operations of the device 900 described in the disclosure. The memory 930 may further store transitory or non-transitory data necessary for the operation of the controller 910.

The methods according to the embodiments descried in the specification or claims of the disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or, the programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

The embodiments herein are provided merely for better understanding of the disclosure, and the present invention should not be limited thereto or thereby. It should be appreciated by one of ordinary skill in the art that various changes in form or detail may be made to the embodiments without departing from the scope of the present disclosure defined by the following claims. Further, each of the above-described embodiments may be combined and operated together as needed, as long as there is no technical inconsistency.

1. A method for handling information related to an artificial intelligence/machine learning (AI/ML) service by an access and mobility management function (AMF) in a wireless communication system, the method comprising:
receiving a registration request message including a list of requested AI/ML operation types from a user equipment (UE);
identifying a list of AI/ML operation types allowed for the UE and at least one operation condition for each AI/ML operation type included in the list of AI/ML operation types allowed for the UE;
determining whether the UE is allowed to use at least one AI/ML operation type included in the list of requested AI/ML operation types, based on the list of requested AI/ML operation types, the list of AI/ML operation types allowed for the UE, and the at least one operation condition; and
transmitting a registration reject message to the UE in case of determining that the UE is not allowed to use the at least one AI/ML operation type included in the list of requested AI/ML operation types.

2. The method of claim 1, wherein the list of requested AI/ML operation types includes the at least one AI/ML operation type supported by at least one application installed on the UE.

3. The method of claim 1, wherein identifying the list of AI/ML operation types allowed for the UE and the at least one operation condition comprises:
transmitting a message for requesting subscriber information for the UE to a unified data management (UDM); and
receiving a response message including the list of AI/ML operation types allowed for the UE and the at least one operation condition from the UDM, in response to the message for requesting the subscriber information for the UE,
wherein the list of AI/ML operation types allowed for the UE and the at least one operation condition included in the response message received from the UDM are obtained by the UDM from a user data repository (UDR).

4. The method of claim 1, further comprising:
in case of determining that the UE is allowed to use the at least one AI/ML operation type included in the list of requested AI/ML operation types, transmitting, to a policy control function (PCF), an access and mobility management (AM) policy generation request message for the UE including the list of AI/ML operation types allowed for the UE and the at least one operation condition;
receiving, from the PCF, an AM policy generation response message including a policy control request trigger (PCRT) based on the list of AI/ML operation types allowed for the UE and the at least one operation condition, wherein the PCRT includes at least one of a change in a UE presence in a presence reporting area, a change in network data analytics function (NWDAF) information, and a change in the allowed AI/ML operation types; and
transmitting a registration accept message to the UE in case that the UE meets registration conditions, after receiving the AM policy generation response message.

5. The method of claim 1, further comprising:
transmitting, to a base station associated with the UE, a message for requesting location information about the UE including information about an area of interest, wherein the information about the area of interest includes an identifier of each of at least one tracking area corresponding to an AI/ML service area related to the UE; and
receiving, from the base station, a message including the location information about the UE

6. The method of claim 1, further comprising:
transmitting, to a network data analytics function (NWDAF), a message for requesting collection and analysis of mobility information about the UE including information about an area of interest, wherein the information about the area of interest includes an identifier of each of at least one tracking area corresponding to an AI/ML service area related to the UE; and
receiving a message including at least one of collected mobility information about the UE and analyzed mobility information about the UE from the NWDAF.

7. The method of claim 1, further comprising:
transmitting, to a policy control function (PCF), a UE policy generation request message for the UE including the list of AI/ML operation types allowed for the UE and the at least one operation condition;
receiving, from the PCF, a UE policy generation response message including a UE policy for an AI/ML service for the UE and a policy control request trigger (PCRT) based on the list of AI/ML operation types allowed for the UE and the at least one operation condition; and
transferring the UE policy for the AI/ML service for the UE to the UE,
wherein the UE policy for the AI/ML service includes at least one of a policy related to AI/ML model transfer and a policy related to AI/ML data transfer, each including at least one of a transmission frequency, a transmission size, and a transmission execution time.

8. The method of claim 1, further comprising:
receiving, from the UE, a protocol data unit (PDU) session establishment request including information about an AI/ML operation type of an AI/ML application installed on the UE in case that the AI/ML operation type of the AI/ML application installed on the UE is included in the list of AI/ML operation types allowed for the UE, and the AI/ML operation type of the AI/ML application meets a corresponding operation condition;
in response to receiving the PDU session establishment request, determining whether the UE is located in an AI/ML service area related to the AI/ML operation type of the AI/ML application; and
in case of determining that the UE is located in the AI/ML service area related to the AI/ML operation type of the AI/ML application, transmitting, to a session management function (SMF), a PDU session generation request message including the AI/ML operation type of the AI/ML application, at least one operation condition related to at least one AI/ML operation type, and information indicating that the UE is located in the AI/ML service area related to the AI/ML operation type of the AI/ML application.

9. The method of claim 8, further comprising:
in case that a PDU session establishment accept message is received from the SMF in response to the PDU session generation request message, transmitting, to a base station associated with the UE, an N2 PDU session request message including a non-access stratum (NAS) message including information related to access network resource allocation for the UE.

10. A method for handling information related to an artificial intelligence/machine learning (AI/ML) service by a session management function (SMF) in a wireless communication system, the method comprising:
receiving, from an access and mobility management function (AMF), a protocol data unit (PDU) session generation request message including at least one of an AI/ML operation type of an AI/ML application installed on a user equipment (UE), at least one operation condition related to at least one AI/ML operation type, and information indicating that the UE is located in an AI/ML service area related to the AI/ML operation type of the AI/ML application;
identifying subscriber information required for session management related to the UE, wherein the subscriber information required for the session management related to the UE includes at least one of a list of AI/ML operation types allowed for the UE and at least one operation condition for each AI/ML operation type included in the list of the AI/ML operation types allowed for the UE;
determining whether the AI/ML application is operable in a requested PDU session, based on at least one of the AI/ML operation type of the AI/ML application, the at least one operation condition related to the at least one AI/ML operation type, the information indicating that the UE is located in the AI/ML service area related to the AI/ML operation type of the AI/ML application, and the subscriber information required for the session management related to the UE; and
transmitting a PDU session establishment reject message to the AMF in case of determining that the AI/ML application is not operable in the requested PDU session.

11. The method of claim 10, further comprising:
in case of determining that the AI/ML application is operable in the requested PDU session, transmitting, to a policy control function (PCF), a session management (SM) policy generation request message including at least one of the AI/ML operation type of the AI/ML application, the at least one operation condition related to the at least one AI/ML operation type, and the information indicating that the UE is located in the AI/ML service area related to the AI/ML operation type of the AI/ML application; and
receiving, from the PCF, an SM policy generation response message including an SM policy and a PCRT, determined based on at least one of the AI/ML operation type of the AI/ML application, the at least one operation condition related to the at least one AI/ML operation type, and the information indicating that the UE is located in the AI/ML service area related to the AI/ML operation type of the AI/ML application.

12. The method of claim 10, further comprising:
transmitting, to a network data analytics function (NWDAF), a message for requesting collection and analysis of mobility information about the UE to monitor the operation condition related to the AI/ML operation type of the AI/ML application,
wherein the message for requesting the collection and analysis of the mobility information about the UE includes information about an area of interest, and
wherein the information about the area of interest includes an identifier of each of at least one tracking area corresponding to an AI/ML service area related to the UE.

13. A device for an access and mobility management function (AMF) in a wireless communication network, comprising:
a transceiver; and
at least one processor connected to the transceiver, wherein the at least one processor is configured to:
receive a registration request message including a list of requested AI/ML operation types from a user equipment (UE);
identify a list of AI/ML operation types allowed for the UE and at least one operation condition for each AI/ML operation type included in the list of AI/ML operation types allowed for the UE;
determine whether the UE is allowed to use at least one AI/ML operation type included in the list of requested AI/ML operation types, based on the list of requested AI/ML operation types, the list of AI/ML operation types allowed for the UE, and the at least one operation condition; and
transmit a registration reject message to the UE in case of determining that the UE is not allowed to use the at least one AI/ML operation type included in the list of requested AI/ML operation types.

14. The device of claim 13, wherein the list of requested AI/ML operation types includes the at least one AI/ML operation type supported by at least one application installed on the UE.

15. The device of claim 13, wherein to identify the list of AI/ML operation types allowed for the UE and the at least one operation condition, the at least one processor is configured to:
transmit a message for requesting subscriber information for the UE to a unified data management (UDM); and
receive a response message including the list of AI/ML operation types allowed for the UE and the at least one operation condition from the UDM, in response to the message for requesting the subscriber information for the UE,
wherein the list of AI/ML operation types allowed for the UE and the at least one operation condition included in the response message received from the UDM are obtained by the UDM from a user data repository (UDR).
